(19) United States
(12) Patent Application Publication
(10) Pub. No.: US 2026/0300176 A1
(43) Pub. Date: Oct. 1, 2026

(54) CACHE DATA MANAGEMENT IN MULTICORE SYSTEMS

(71) Applicant: Advanced Micro Devices, Inc., Santa Clara, CA (US)

(72) Inventor: Patrick J. Shyvers, Ft. Collins, CO (US)

(21) Appl. No.: 19/095,719

(22) Filed: Mar. 31, 2025

(51) Int. Cl. G06F 12/0811; G06F 12/084; G06F 12/126

(52) U.S. Cl. CPC G06F 12/0811; G06F 12/084; G06F 12/126

(57) ABSTRACT

An implementation is a method for managing cache data in a multicore processor system includes detecting a request for exclusive access to a cacheline by a first processor core, granting exclusive access to the cacheline to the first processor core and invalidating copies of the cacheline in other processor cores, after the first processor core writes to the cacheline, copying the cacheline to a last level cache (LLC) when a number of invalidated copies of the cacheline exceeds a predetermined threshold, and servicing read requests for the cacheline from the LLC.

### BACKGROUND

Cache memory plays a crucial role in modern computing systems by storing frequently accessed data closer to the processor, thereby reducing access times and improving overall system performance. As processor speeds continue to outpace memory speeds, effective cache management becomes increasingly integral to system operation.

Modern computing systems often employ multiprocessor architectures to enhance performance and efficiency. These systems typically utilize cache memory hierarchies to reduce data access latency and improve overall system throughput. In multiprocessor systems, maintaining cache coherency across multiple processors is crucial for ensuring data consistency and correctness of program execution.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a block diagram of a processing system, in accordance with some implementations.

FIG. 2 illustrates a block diagram of a processor system with multiple cores and cache levels, in accordance with some implementations.

FIG. 3 illustrates a block diagram of a set-associative cache structure, in accordance with some implementations.

FIG. 4 illustrates a multiprocessor system demonstrating cache coherency challenges, in accordance with some implementations.

FIG. 5 illustrates a multiprocessor system with Auto-Demote activated, in accordance with some implementations.

FIG. 6 illustrates a flowchart of a method for managing cache data in a multiprocessor system, in accordance with some implementations.

FIG. 7 illustrates a flowchart of a method for managing cache data based on read requests, in accordance with some implementations.

FIG. 8 illustrates a timeline comparison of sequential and Auto-Demote approaches to data sharing, in accordance with some implementations.

Corresponding numerals and symbols in the different figures generally refer to corresponding parts unless otherwise indicated. The figures are drawn to clearly illustrate the relevant aspects of the implementations and are not necessarily drawn to scale. The edges of features drawn in the figures do not necessarily indicate the termination of the extent of the feature.

### DETAILED DESCRIPTION OF ILLUSTRATIVE IMPLEMENTATIONS

The making and using of various implementations are discussed in detail below. It should be appreciated, however, that the various implementations described herein are applicable in a wide variety of specific contexts. The specific implementations discussed are merely illustrative of specific ways to make and use various implementations, and should not be construed in a limited scope.

Reference to “an implementation” or “one implementation” in the framework of the present description is intended to indicate that a particular configuration, structure, or characteristic described in relation to the implementation is included in at least one implementation. Hence, phrases such as “in one implementation” that may be present in one or more points of the present description do not necessarily refer to one and the same implementation. Moreover, particular conformations, structures, or characteristics may be combined in any adequate way in one or more implementations. The references used herein are provided merely for convenience and hence do not define the extent of protection or the scope of the implementations.

Implementations of the present disclosure address challenges in efficiently managing cache data access across multiple processors in computing systems ranging from smartphones to data centers. In these systems, multiple processor cores frequently need to access and modify shared data, which can lead to performance degradation if not managed properly.

A significant challenge arises when multiple processors attempt to read data that has recently been modified by one processor. Standard cache coherency protocols require each processor to request the updated data directly from the processor that made the change. This creates a bottleneck as that single processor becomes overwhelmed with requests, leading to increased latency and bandwidth pressure.

Implementations described herein introduce an innovative cache management approach-also referred to as an Auto-Demote approach. This approach proactively identifies scenarios where multiple processors (and/or multiple cores within a processor) are likely to read recently written data. When such a situation is detected, the system preemptively copies the relevant data to a shared cache, such as a last-level cache (LLC), before multiple read requests occur. This transforms the data sharing model from a sequential, bottlenecked process to an efficient parallel distribution system.

The Auto-Demote system leverages the observability of coherency states and traffic patterns within the cache hierarchy to make informed predictions about data access patterns. By analyzing factors such as the number of processors sharing a particular cacheline or the frequency and timing of read requests, the system can predict when widespread data access is likely to occur.

The Auto-Demote approach offers several advantages. One advantage is reduced latency for multiple readers accessing recently modified data. By storing a copy of the data in a centralized, shared cache, the system can service multiple read requests simultaneously, eliminating the need for each reader to query the original writing processor individually. Another advantage is alleviated bandwidth pressure on individual processor cores. In conventional systems, a core that has recently written data may become overwhelmed with read requests from other cores, impacting its ability to perform other tasks efficiently. By offloading the responsibility of servicing read requests to the shared cache, the Auto-Demote system helps distribute the workload more evenly across the system. Another advantage is that it is hardware-based without needing software intervention. The improvements in cache management occur automatically within the computer hardware, without any participation or knowledge from software. This hardware-based approach ensures that the benefits are realized transparently, without modifications to existing software or additional programming overhead.

In testing scenarios, implementations of the Auto-Demote system have demonstrated approximately fourfold performance increases on workloads characterized by frequent sharing of newly modified data among multiple processors.

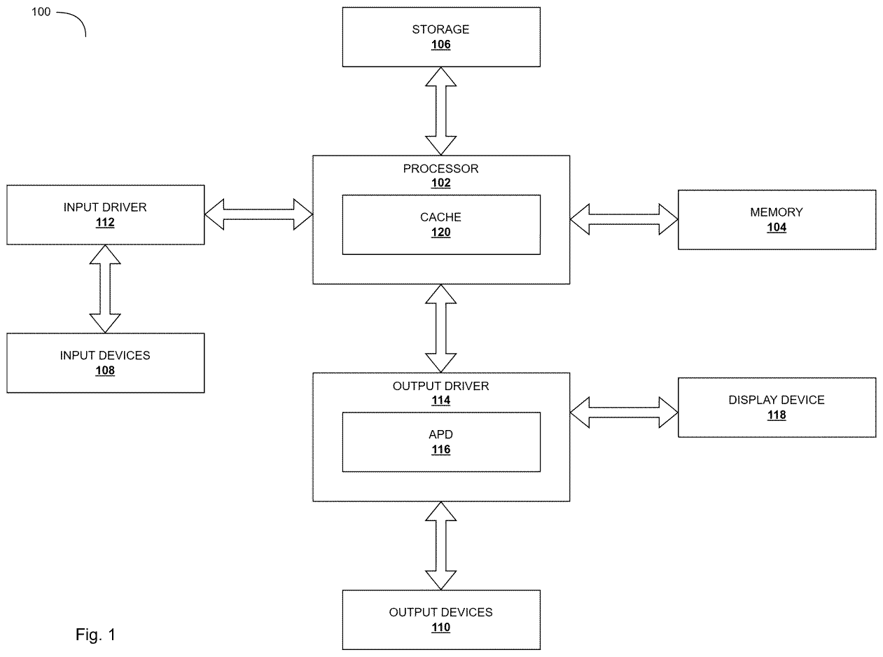

FIG. 1 illustrates a block diagram of a processing system according to various implementations. The processing system includes a device 100 comprising various components for data processing and management. The device 100 includes a processor 102, which functions as the central processing unit responsible for executing instructions and managing overall system operations. The processor 102 includes one or more processor cores, which can be either CPUs or GPUs, or a combination thereof located on the same die. The processor 102 is directly linked to and interacts with a cache 120 for swift data access. The memory 104 may be positioned on the same die as the processor 102 or located separately, depending on the specific implementation.

The device 100 may be embodied in various forms, such as a computer, gaming device, handheld device, set-top box, television, mobile phone, tablet computer, or other computing devices. In addition to the processor 102, the device 100 includes components such as memory 104, storage 106, input devices 108, output devices 110, input drivers 112, and output drivers 114. These drivers may be implemented as hardware, software, or a combination thereof, and are designed to control the operation of their respective devices, facilitating data transfer between the processor and the input/output components.

The cache 120 is implemented as a small, fast memory that stores recently used data and instructions. In some cases, the cache 120 is organized into multiple levels, such as a level 1 (L1) cache and a level 2 (L2) cache, to balance speed and capacity. The cache 120 may represent one or more cache memories of the processor 102, potentially organized into a cache hierarchy. The cache 120 helps reduce the average time to access data from main memory by keeping frequently accessed data closer to the processor 102. In some implementations, the cache 120 is part of a hierarchical cache structure that includes a last level cache (LLC) shared by multiple processors in a multiprocessor system.

The memory 104 is implemented as random access memory (RAM) for storing data and instructions that are not immediately required by the processor 102. In some implementations, the memory 104 may be located on the same die as the processor 102, or may be located separately. The memory 104 works in conjunction with the cache 120 to provide a hierarchical storage system, where frequently accessed data is stored in the faster cache 120 while less frequently accessed data remains in the slower but larger memory 104.

The storage 106 is included in the computing system for long-term data retention. In some cases, the storage 106 may be a non-volatile storage device such as a hard disk drive, solid-state drive, optical disk, or flash drive. Data may be transferred between the storage 106, memory 104, and cache 120 as needed to support efficient processing operations.

The computing system includes input devices 108 and output devices 110 to facilitate user interaction. Input devices 108 may include keyboards, keypads, touchscreens, touch pads, detectors, microphones, accelerometers, gyroscopes, biometric scanners, or network connections. Output devices 110 may include displays, speakers, printers, haptic feedback devices, lights, antennas, or network connections.

The input driver 112 manages communications between input devices 108 and the processor 102, while the output driver 114 handles data transfer from the processor 102 to output devices 110. The input driver 112 and output driver 114 may include hardware, software, and/or firmware components configured to interface with and drive their respective devices.

The output driver 114 may include an accelerated processing device (APD) 116, which in some implementations may be coupled to a display device 118. The APD 116 may be configured to accept compute commands and graphics rendering commands from the processor 102, process those commands, and provide pixel output to the display device 118. In some implementations, the APD 116 may include one or more parallel processing units configured to perform computations in accordance with a single-instruction-multiple-data (SIMD) paradigm.

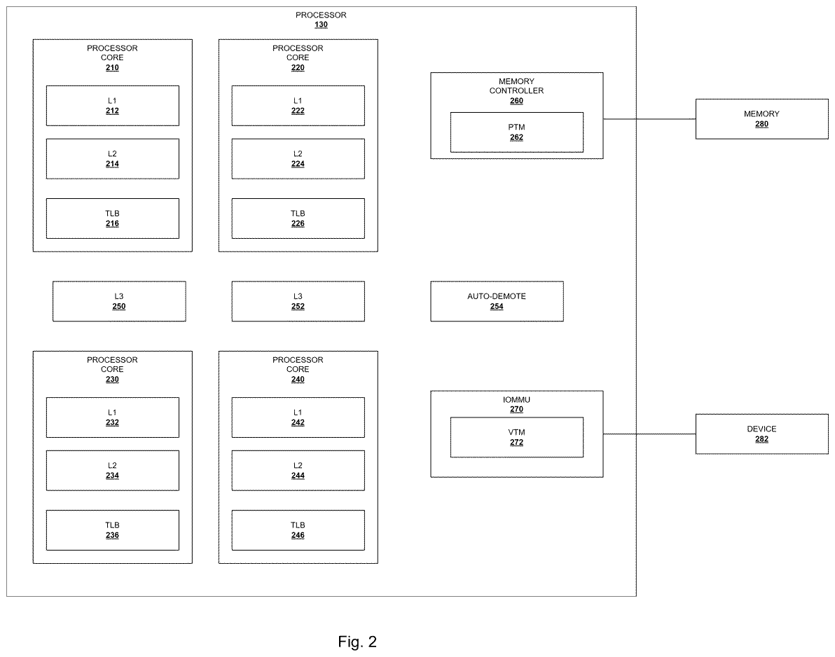

FIG. 2 illustrates a processor system architecture according to various implementations. The processor system 130 includes multiple processor cores arranged in a quad-core configuration. A first processor core 210, a second processor core 220, a third processor core 230, and a fourth processor core 240 are included in the processor system 130. Each processor core has a similar hierarchical cache and translation buffer structure.

The first processor core 210 includes a first level one cache 212, a first level two cache 214, and a first translation buffer 216. Similarly, the second processor core 220 contains a second level one cache 222, a second level two cache 224, and a second translation buffer 226. The third processor core 230 comprises a third level one cache 232, a third level two cache 234, and a third translation buffer 236. The fourth processor core 240 includes a fourth level one cache 242, a fourth level two cache 244, and a fourth translation buffer 246.

The processor system 130 also includes two level three caches: a first level three cache 250 and a second level three cache 252, which are shared between the processor cores. In some implementations, the first level three cache 250 and the second level three cache 252 function as a last level cache (LLC) for the processor system 130. The LLC has observability of the coherency state and coherent request traffic within the processor system 130. This observability allows the LLC to gather information about the behavior of many processors and apply this information to decision-making processes related to cache management, including Auto-Demote operations.

A memory controller 260 is included in the processor system 130. The memory controller 260 manages communication between the processor cores and a system memory 280. The memory controller 260 contains a page table module 262, which assists in managing virtual memory operations.

An input output memory unit 270 is included to facilitate communication between the processor system 130 and a peripheral device 282. The input output memory unit 270 contains a virtual table module 272, which assists in managing virtual memory operations related to input/output processes.

The cache hierarchy in the processor system 130 is structured to provide efficient data access at multiple levels. The level one caches (212, 222, 232, 242) are private to each processor core, providing fast access to frequently used data. The level two caches (214, 224, 234, 244) are also private to each core, offering a larger storage capacity than the level one caches. The level three caches (250, 252) are shared among all cores, providing a large storage capacity for data that may be accessed by multiple cores.

In implementations of the Auto-Demote system, the orchestration and triggering of cache management operations is performed in the LLC. This centralized approach allows the LLC to leverage information about the behavior of multiple processors when making decisions about data placement and coherency management. For example, the LLC may use its observability of coherency states and request traffic to predict when multiple processors are likely to read recently written data, and may proactively copy such data to the shared cache to improve access efficiency.

The translation buffers (216, 226, 236, 246) in each core work in conjunction with the page table module 262 and the virtual table module 272 to manage address translation between virtual and physical memory spaces. This enables efficient memory management and protection in the processor system 130.

In various implementations, the processor system 130 includes an auto-demote circuit 254 (also referred to as a cache management circuit 254) that manages the cache coherency and data movement operations for improved sharing of recently written data. As illustrated in FIG. 2, the auto-demote circuit 254 may be implemented within or in association with the level three caches 250, 252 that function as the last level cache (LLC). The auto-demote circuit 254 may be implemented as hardware circuitry, firmware, or a combination thereof, and is responsible for detecting cacheline access patterns, managing coherency states, and initiating data copying operations between different cache levels.

The auto-demote circuit 254 is configured to detect when a processor core (210, 220, 230, or 240) obtains exclusive access to a cacheline and to track the invalidation of copies in other processor cores. Based on this information, the auto-demote circuit 254 can initiate a copy of the cacheline to the level three caches 250, 252 (functioning as the LLC) to facilitate efficient data sharing.

In some implementations, the auto-demote circuit 254 is integrated within the level three caches 250, 252, allowing it to directly observe coherency state changes and request traffic. This integration enables the auto-demote circuit 254 to leverage information about the behavior of many processors when making decisions about when to trigger copy operations.

The auto-demote circuit 254 interacts with the coherency mechanisms that manage the coherency states of cachelines across the various cache levels (level one caches 212, 222, 232, 242; level two caches 214, 224, 234, 244; and level three caches 250, 252), ensuring that when a cacheline is copied to the level three caches 250, 252, the appropriate state transitions occur in the processor caches. For example, when a cacheline is copied from a processor's cache to the level three caches 250, 252, the auto-demote circuit 254 may cause the coherency state of the cacheline in the processor's cache to change from exclusive to shared.

Additionally, the auto-demote circuit 254 interfaces with the replacement policy mechanisms for cachelines in the level three caches 250, 252, potentially giving higher retention priority to cachelines that have been copied through the auto-demote mechanism based on their expected access patterns.

In the write-triggered implementation, the auto-demote circuit 254 detects requests for exclusive access to cachelines and tracks the number of copies that are invalidated. After the writing processor modifies the cacheline, the auto-demote circuit 254 may initiate a copy of the cacheline to the level three caches 250, 252 based on the previous sharing patterns.

In the read-triggered implementation, the auto-demote circuit 254 detects multiple read requests for the same cacheline from different processors within a specific timeframe.

Upon detecting this pattern, the auto-demote circuit 254 initiates a copy-back operation to bring the most recent version of the cacheline into the level three caches 250, 252 for efficient servicing of the read requests.

Through these mechanisms, the auto-demote circuit 254 plays a central role in optimizing cache utilization in multiprocessor environments, reducing latency for multiple readers accessing recently modified data and alleviating bandwidth pressure on individual processor cores.

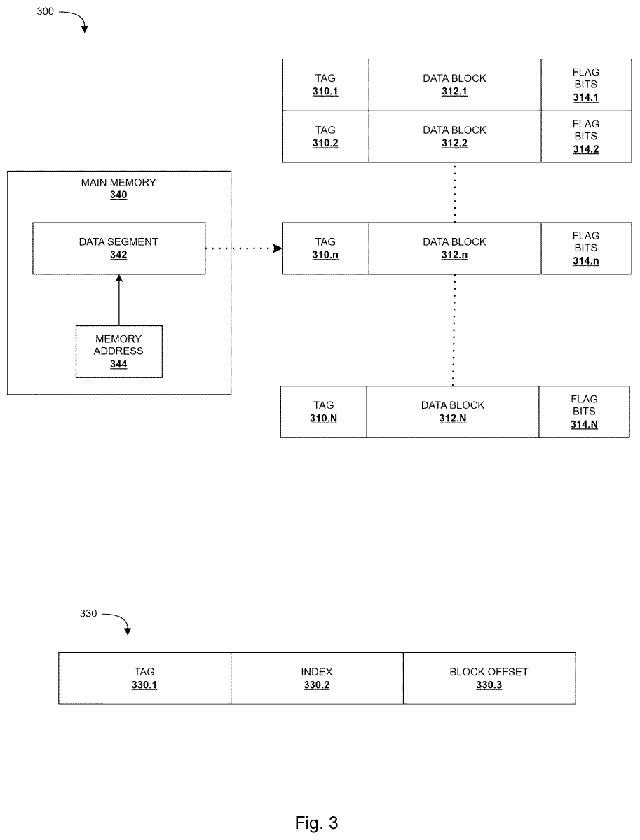

FIG. 3 illustrates a cache structure and operation according to various implementations. A cache 300 is organized into multiple sets, each containing several ways. In some cases, the cache 300 may be a 4-way set-associative cache, meaning each set contains four ways. The cache 300 includes multiple entries, each comprising a tag field, a data block, and flag bits.

A memory address 330 is used to access data within the cache 300. The memory address 330 is divided into three fields: a tag field 330.1, an index field 330.2, and an offset field 330.3. The bits that represent the memory address are partitioned into these groups based on their bit significance. The index field 330.2 is used to select a specific set within the cache 300.

Within each set, the cache 300 stores multiple entries. A first tag 310.1, a second tag 310.2, an intermediate tag 310.n, and a final tag 310.N correspond to different ways within a set. Similarly, a first data block 312.1, a second data block 312.2, an intermediate data block 312.n, and a final data block 312.N store the actual cached data for each way. Additionally, a first flag bits 314.1, a second flag bits 314.2, an intermediate flag bits 314.n, and a final flag bits 314.N maintain status information for each cache entry.

When accessing data, the tag field 330.1 of the memory address 330 is compared against the tags stored in each way of the selected set. If a match is found, the corresponding data block is retrieved. The offset field 330.3 is then used to select the specific data within the cache line.

A main memory 340 works in conjunction with the cache 300. The main memory 340 includes a data segment 342 and an address register 344. When data is not found in the cache 300, it is retrieved from the main memory 340 and stored in the cache 300 for future access.

The block offset 330.3, having the least significant bits of the address 330, provides an offset pointing to the location in the data block where the requested data segment is stored. For example, if a data block is a b-byte block, the block offset 330.3 will need to be log2(b) bits long. The index 330.2 specifies the set of data blocks in the cache where a particular memory section can be stored. For example, if there are s number of sets, the index 330.2 will need to be log2(s) bits long. The tag 330.1, having the most significant bits of the address 330, associates the particular memory section with the line in the set it is stored in.

The set-associative organization of the cache 300 allows for efficient data retrieval while balancing the trade-offs between fully associative and direct-mapped cache designs. By using multiple ways within each set, the cache 300 reduces conflict misses and improves overall cache performance.

The cache structure and operation illustrated in FIG. 3 provides efficient data access and management in a processor system. The set-associative organization balances the trade-offs between fully associative and direct-mapped cache designs, offering a compromise between access speed and hit rate.

In some implementations, the performance of the cache 300 is evaluated using microbenchmarks and cache occupancy monitoring. These techniques allow for the detection and analysis of cache behavior, including the effectiveness of data placement and replacement policies under Auto-Demote operations.

In implementations of the Auto-Demote system, determining when multiple processors are likely to read recently written data is an aspect of the decision-making process. The term multiple in this context refers to more than one other processor that might request the same cacheline. However, in some implementations, the system may employ a more refined threshold based on system characteristics.

The benefit of using Auto-Demote scales with the number of processors that are likely to request the recently written data. As the number of potential readers increases, the performance advantage of having a centrally available copy in the LLC becomes more pronounced.

In some implementations, this determination may be based on a predetermined threshold number of processors (or cores). For example, the system might trigger Auto-Demote when more than two other processors are expected to read the data, as this is where the benefits begin to become substantial in many system configurations. Based on analysis of typical multiprocessor behavior, the benefits become particularly significant when three or more processors are expected to read the recently written data.

In some implementations, particularly those designed for scalability across different processor configurations, the threshold for determining when to trigger Auto-Demote may be defined as a ratio or percentage of the total number of threads or cores in the system. For example, in a system with 16 cores, “many” processors might be defined as more than 25% of the cores (i.e., more than 4 cores) that are expected to access the same cacheline within a specified time period. As another example, in a system with 100 cores or more, “many” processors might be defined as 5% of the cores (i.e., more than 5 cores) that are expected to access the same cacheline within a specified time period. This flexible threshold allows the cache management system to adapt to different processor configurations and workloads. It is worth noting that the terms “multiple” and “many” may be used somewhat interchangeably in this context.

The determination of whether multiple processors will read the recently written data can be made through various mechanisms, including: Analysis of coherency states before a write operation; Observation of historical access patterns; and/or Detection of temporal locality in read requests; Monitoring of concurrent read requests within a specific time window. These mechanisms enable the Auto-Demote system to make informed predictions about future data access patterns and proactively optimize cache utilization accordingly.

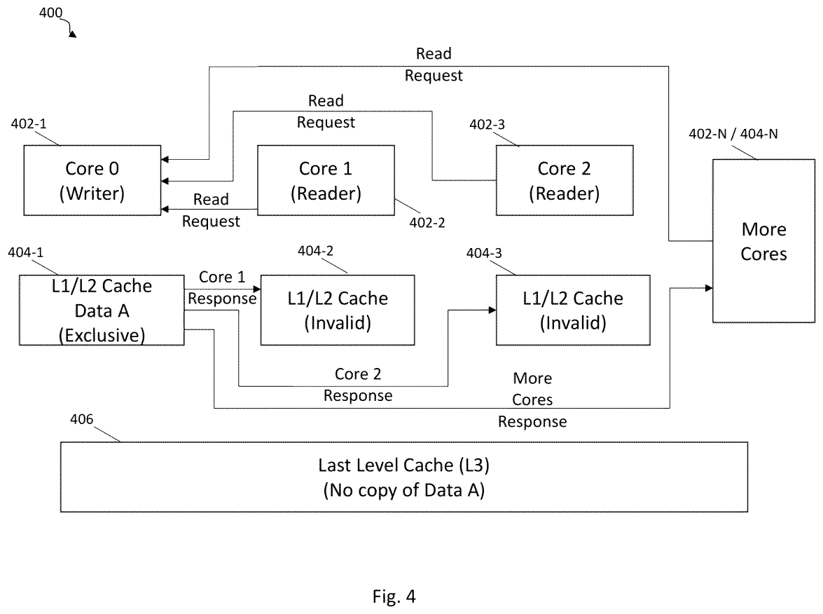

FIG. 4 illustrates a multiprocessor system 400 demonstrating cache coherency challenges according to various implementations. Cache coherency challenges in multiprocessor systems arise when multiple processors have local copies of shared data in their respective caches. The multiprocessor system 400 includes a writer core 402-1 and multiple reader cores including a reader core 402-2, a reader core 402-3, and additional cores 402-N. At a particular moment in time, the writer core 402-1 has an exclusive cache 404-1 containing Data A, while the reader core 402-2 has an invalid cache 404-2, the reader core 402-3 has an invalid cache 404-3, and the additional cores 402-N have additional caches 404-N. A last level cache 406 is also present in the multiprocessor system 400.

In this snapshot of the multiprocessor system 400, when the writer core 402-1 modifies Data A in the exclusive cache 404-1, the system needs to ensure that the invalid cache 404-2, the invalid cache 404-3, and the additional caches 404-N are updated or invalidated to maintain data consistency. This process introduces inefficiencies in data sharing, including increased memory traffic, higher latency for memory operations, and reduced overall system performance as processors spend time waiting for data to be synchronized across the system.

Before the write operation by the writer core 402-1, copies of the cacheline containing Data A are invalidated in the invalid cache 404-2, the invalid cache 404-3, and the additional caches 404-N of the other processors. This invalidation process further contributes to system overhead and latency.

When other processors subsequently need to read the updated Data A, they must request it directly from the writer core 402-1, creating a sequential bottleneck that scales poorly as the number of reader cores increases. This becomes particularly problematic in systems with high degrees of data sharing, where a recently modified cacheline might be needed by numerous processors simultaneously.

The benefit of copying Data A to the last level cache 406 scales with the number of interested parties. As the number of reader cores (402-2, 402-3, 402-N) that need to access the recently modified data increases, the potential performance improvement from having a shared copy in the last level cache 406 becomes more significant. This scaling effect highlights the importance of efficient cache management strategies in multiprocessor systems with frequent data sharing.

It is important to note that FIG. 4 represents one or more points in time, and the states of the cores and caches may change dynamically as different cores read and write data. The figure serves to illustrate one particular scenario to explain the cache coherency challenges that may arise in such systems.

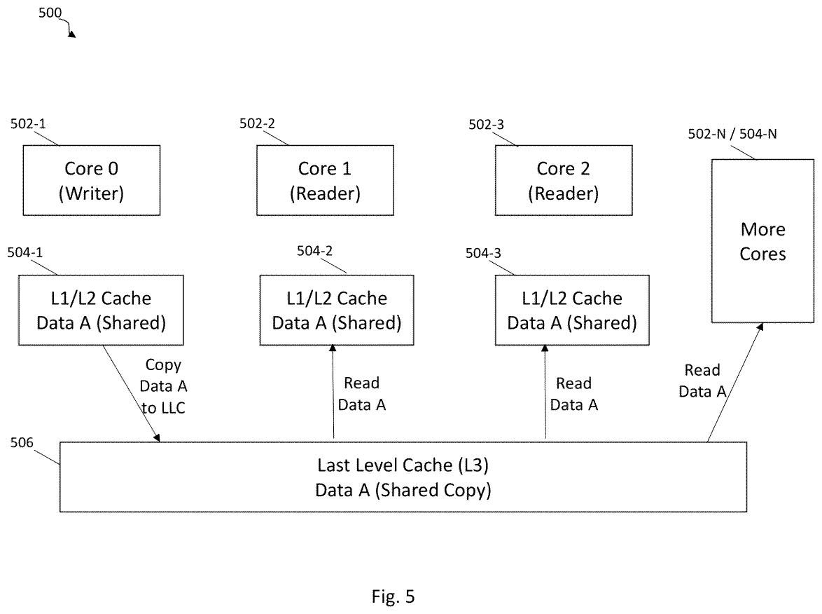

FIG. 5 illustrates a system 500 with Auto-Demote activated according to various implementations. The system 500 includes multiple processor cores, including a processor core 502-1 (Core 0), a processor core 502-2 (Core 1), a processor core 502-3 (Core 2), and additional processor cores 502-N. Each processor core 502 is associated with one or more cache modules 504, which may include L1 and L2 caches. These cache modules 504 may be implemented as separate L1 and L2 caches or combined into a single cache, depending on the specific system configuration. The processor core 502-1 is associated with a cache module 504-1, the processor core 502-2 is associated with a cache module 504-2, the processor core 502-3 is associated with a cache module 504-3, and the additional processor cores 502-N are associated with additional cache modules 504-N. A last level cache 506 is shared among the processor cores 502 in the system 500, providing a common cache resource for data sharing and coherency management.

The figure represents a snapshot of the Auto-Demote configuration of cache memory at a particular moment in time. Initially, Core o has written to Data A in its associated cache module 504-1, which would typically result in an exclusive state for that data.

The Auto-Demote system operates by detecting write operations to cachelines performed by processor cores. In this case, the system 500 has detected that the first processor core 502-1 performed a write operation to a cacheline containing Data A in the first cache module 504-1. The system 500 then predicts if multiple other processor cores are likely to read the cacheline.

To make this prediction, the system 500 analyzes coherency traffic patterns or checks the coherency state of the cacheline for other processor cores. In some implementations, if the coherency state indicates that the cacheline was previously shared by more than a threshold number of other processor cores before the write operation (which required invalidating those copies), the system 500 predicts that multiple reads are likely to occur again.

When the system 500 determines that multiple other processor cores are likely to read the cacheline, the Auto-Demote mechanism triggers a copy operation. This copy operation transfers the cacheline from the first cache module 504-1 to the last level cache 506. The arrow labeled “Copy Data A to LLC” in FIG. 5 illustrates this transfer process. Simultaneously, the state of Data A in Core 0's cache module 504-1 is downgraded from exclusive to shared, as indicated by “Data A (Shared)” in the figure.

After the cacheline has been copied to the last level cache 506, subsequent read requests from other processor cores are serviced directly from the last level cache 506 instead of from the first processor core 502-1. This process is illustrated in FIG. 5 by the arrows labeled “Read Data A” pointing from the last level cache 506 to the second cache module 504-2, the third cache module 504-3, and the additional cache modules 504-N. The last level cache 506 now contains a shared copy of Data A, as indicated by “Data A (Shared Copy)” in the figure.

The Auto-Demote system transforms the data sharing model from a sequential process to an efficient parallel distribution system. By copying frequently accessed data to the last level cache 506, the system 500 reduces latency for multiple readers accessing recently modified data. This approach allows the last level cache 506 to service multiple read requests simultaneously, eliminating the need for each reader to query the original writing processor core individually.

The Auto-Demote system alleviates bandwidth pressure on individual processor cores. By offloading the responsibility of servicing read requests to the last level cache 506, the system 500 helps distribute the workload more evenly across the multiprocessor environment. This distribution allows the writing processor core to continue with other operations without interruption from numerous read requests.

The caches of all cores (504-1, 504-2, 504-3, 504-N) may now contain Data A in a shared state, enabling consistent access across the system. The last level cache 506 serves as the central distributor of the data, efficiently handling multiple simultaneous read requests.

The Auto-Demote system, as illustrated in FIG. 5, provides benefits in scenarios involving frequent data sharing between processor cores. By proactively identifying and addressing potential bottlenecks in data access, the system 500 enhances overall efficiency in multiprocessor environments.

It is important to note that FIG. 5 represents a specific scenario in the Auto-Demote process, and the states of the cores and caches may change dynamically as different cores read and write data in a functioning system.

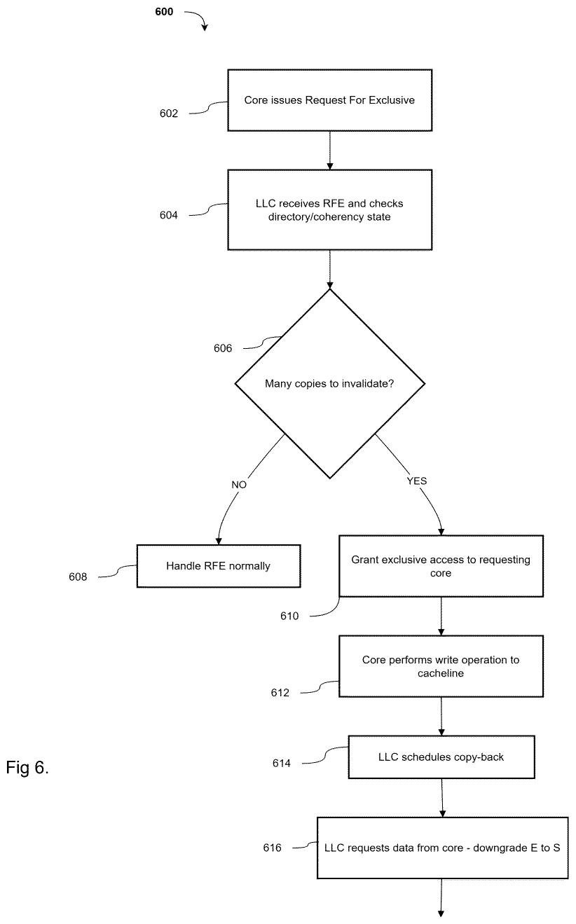

FIG. 6 illustrates a flowchart of a method 600 for managing cache data in a multiprocessor system according to various implementations. The method 600 implements a write-triggered Auto-Demote technique that improves cache efficiency during write operations.

The process begins at step 602, where a processor core issues a Request For Exclusive (RFE) for a cacheline. This RFE indicates the core's intention to modify the cacheline data, potentially requiring exclusive ownership to maintain cache coherency.

At step 604, the Last Level Cache (LLC) receives the RFE and performs an analysis of the directory or coherency state information. During this analysis, the LLC examines which other processor cores currently have copies of the cacheline that need to be invalidated due to the impending write operation.

The process continues to decision point 606, where the LLC evaluates whether many copies of the cacheline need to be invalidated. This determination is based on whether the number of cores holding valid copies exceeds a predetermined threshold. In some implementations, this threshold may be configured based on system architecture and workload characteristics, as described earlier in the determination of “many” processors.

If the decision at step 606 determines there are not many copies to invalidate (NO path), the method proceeds to step 608, where the RFE is handled through the conventional coherency protocol without activating the Auto-Demote mechanism. This path represents the standard RFE handling when the cacheline is not widely shared.

However, if the decision at step 606 determines there are many copies to invalidate (YES path), the method advances to step 610, where exclusive access is granted to the requesting core. This granting of exclusive access includes invalidating existing copies in other cores' caches.

Following step 610, the method proceeds to step 612, where the requesting core performs its write operation to the cacheline. At this point, the core has exclusive access and can modify the data.

At step 614, the Auto-Demote mechanism activates, and the LLC schedules a copy-back operation. This scheduling occurs based on the prediction that the newly written data may soon be requested by multiple cores, as inferred from the high number of copies that were invalidated during the RFE process.

The method concludes at step 616, where the LLC requests the updated data from the core that performed the write. This operation causes the core's cacheline state to be downgraded from Exclusive (E) to Shared(S). The LLC now maintains a copy of the most recent data, positioned to efficiently service subsequent read requests from other cores.

This implementation of write-triggered Auto-Demote enables the system to anticipate multiprocessor sharing patterns and respond proactively. By positioning a copy of newly written data in the LLC before it is widely requested, the system reduces latency for readers and minimizes bandwidth pressure on the writer core under heavy sharing conditions.

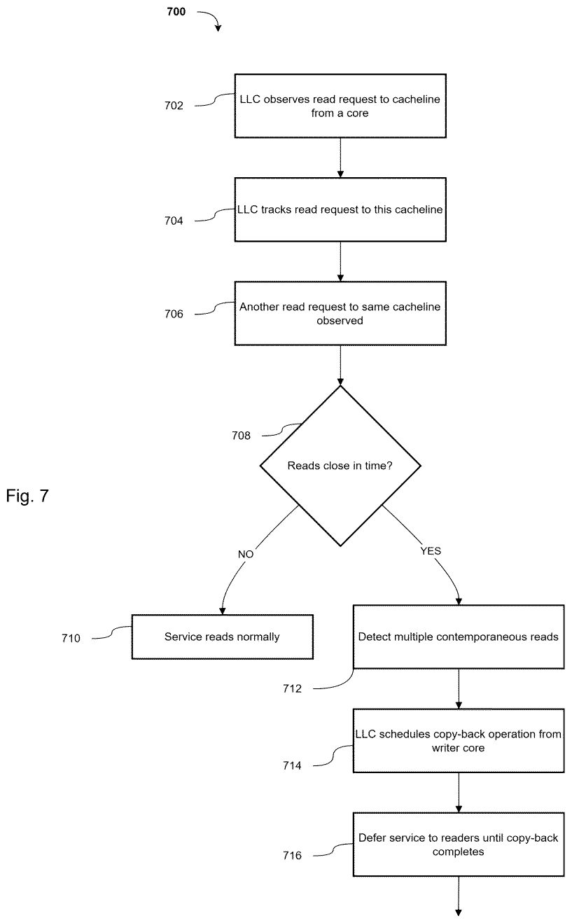

FIG. 7 illustrates a flowchart of a method 700 for managing cache data in a multiprocessor system according to various implementations. The method 700 implements a read-triggered Auto-Demote technique that improves cache efficiency based on observed read patterns.

The process begins at step 702, where the Last Level Cache (LLC) observes a read request to a specific cacheline from a processor core. This initial observation serves as a starting point for potential pattern detection.

At step 704, the LLC records and tracks this read request, maintaining information about the cacheline address, the requesting core, and the timing of the request. This tracking mechanism establishes a baseline for identifying subsequent access patterns.

The process continues to step 706, where the LLC observes another read request to the same cacheline. This second request may originate from a different processor core than the first request, potentially indicating sharing behavior among multiple cores.

At decision point 708, the LLC evaluates whether these observed read requests are “close in time” to each other. This temporal proximity assessment determines whether the requests are part of the same logical workflow or independent operations. The bounds of “close in time” depends on system implementation and may refer to requests that arrive while the cache is still processing the first request, or requests that arrive before the completion of processing the first request.

If the decision at step 708 determines the reads are NOT close in time (NO path), the method proceeds to step 710, where the LLC services the read requests through normal cache coherency protocols without activating Auto-Demote.

However, if the decision at step 708 determines the reads ARE close in time (YES path), the method advances to step 712, where the LLC recognizes a pattern of multiple contemporaneous reads to the same cacheline. This pattern suggests that the cacheline is being shared among multiple cores in a synchronized or related processing workload.

Following this detection, at step 714, the LLC schedules a copy-back operation from the writer core that currently owns the most recent version of the cacheline data. This step represents the core Auto-Demote action, where the LLC proactively obtains a copy of the data.

The method concludes at step 716, where the LLC temporarily defers servicing the pending read requests until the copy-back operation completes. Once the LLC obtains the copy, it distributes the data to all requesting cores from a centralized location.

This implementation of read-triggered Auto-Demote offers advantages over relying solely on write-based triggers. It enables the system to detect sharing patterns dynamically based on actual read behavior. The approach activates Auto-Demote even in cases where a write-based trigger might not, such as when the initial sharing pattern wasn't detected during the exclusive request phase but emerges later during read operations.

The method helps distribute recently modified data more efficiently by centralizing it in the LLC, providing performance benefits through reduced latency, decreased bandwidth consumption on the writer core, and improved scalability as the number of reader cores increases. The implementation achieves performance improvements in workloads with synchronized read patterns from multiple cores.

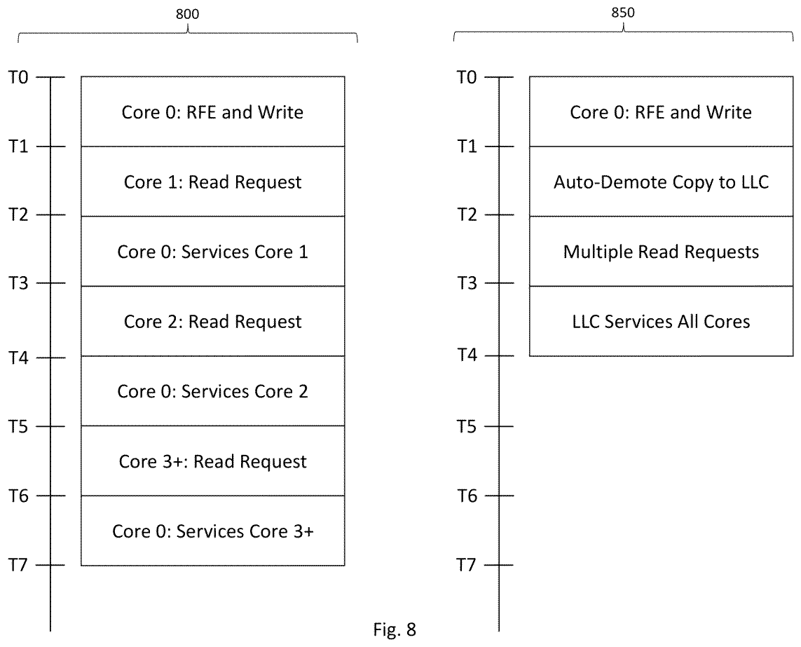

FIG. 8 illustrates timeline diagrams comparing sequential cache management with the Auto-Demote approach according to various implementations. A first sequence diagram 800 shows the sequential approach, while a second sequence diagram 850 demonstrates the Auto-Demote approach.

In the first sequence diagram 800, which represents the sequential approach:

From the first time interval T0 to the second time interval T1, Core 0 performs a Request For Exclusive (RFE) and writes to Data A.

From the second time interval T1 to the third time interval T2, Core 1 sends a read request for the updated data.

During the third time interval T2 to the fourth time interval T3, Core 0 services Core 1's request individually.

From the fourth time interval T3 to the fifth time interval T4, Core 2 sends a read request.

During the fifth time interval T4 to the sixth time interval T5, Core 0 services Core 2's request individually.

From the sixth time interval T5 to the seventh time interval T6, additional cores (Core 3+) send read requests.

During the seventh time interval T6 to the eighth time interval T7, Core 0 services these additional requests.

The total process in the sequential approach requires 7 time units (T0-T7) to complete.

The second sequence diagram 850 illustrates the Auto-Demote approach:

From the first time interval T0 to the second time interval T1, Core 0 performs the same RFE and write operation as in the sequential approach.

From the second time interval T1 to the third time interval T2, the Auto-Demote mechanism automatically copies the data to the last level cache 406.

During the third time interval T2 to the fourth time interval T3, multiple read requests from all cores arrive simultaneously.

From the fourth time interval T3 to the fifth time interval T4, the last level cache 406 services all cores in parallel.

The total process in the Auto-Demote approach requires only 4 time units (T0-T4) to complete.

The comparison demonstrates a significant improvement in data distribution efficiency, with the Auto-Demote approach completing at T4 while the sequential approach requires until T7. This efficiency gain is attributed to the parallel servicing of read requests from the last level cache 406, eliminating the need for sequential responses from the writer core.

In addition to time savings, the Auto-Demote approach reduces bandwidth pressure on the writer core. In the sequential approach, Core o is responsible for servicing each read request individually, potentially impacting its ability to perform other tasks. With Auto-Demote, the last level cache 406 handles the distribution of data to multiple readers, allowing the writer core to continue with other operations without interruption. This significantly reduced bandwidth pressure on the writer core in the Auto-Demote scenario further contributes to overall system efficiency.

The Auto-Demote system provides an innovative approach to cache management in multiprocessor environments. This system improves cache efficiency and overall system performance by proactively copying recently written data to a shared cache when multiple processors are likely to read the data. The Auto-Demote system reduces latency for multiple readers accessing recently modified data and alleviates bandwidth pressure on individual processor cores.

Auto-Demote is particularly beneficial for certain classes of workloads that exhibit specific sharing patterns. One category includes workloads where multiple worker threads need to access the latest information about something as soon as it becomes available. In these scenarios, the time from getting the latest information to producing meaningful results based on that information is a critical performance metric.

For example, networking applications represent a use case for Auto-Demote. When a network packet arrives, multiple worker threads may need to process different aspects of the packet simultaneously. The speed of delivering the packet data to all software workers becomes a crucial figure of merit. In this scenario, Auto-Demote can significantly improve system throughput by ensuring the packet data is efficiently distributed to all workers from the shared cache rather than sequentially from a single core.

In some implementations, the Auto-Demote system includes mechanisms to gracefully handle cases where the prediction of multiple readers proves incorrect. Two primary recovery mechanisms are employed.

The first is may be referred to as natural cache eviction. If the copied line in the LLC is not accessed by multiple readers as predicted, it will eventually be evicted from the cache through normal replacement policy operations. The LLC can control how strongly the line is held in the cache based on the confidence level of the prediction.

The second method may be referred to as re-acquisition of exclusive rights. If the writing core needs to perform additional writes after Auto-Demote has downgraded its copy to shared status, it simply issues another Request For Exclusive (RFE). Since at this point the line is not widely shared (being present only in the writing core and the LLC), the write-trigger for Auto-Demote will not activate again, allowing normal write operations to proceed.

These recovery mechanisms ensure that incorrect predictions have minimal performance impact while preserving all the benefits when predictions are accurate.

In some implementations, the Auto-Demote system can utilize varying levels of confidence in its predictions to influence cache replacement policies. When the system has high confidence that a cacheline will be accessed by multiple cores (such as when a large number of cores previously had copies before invalidation), it can install the line in the LLC with a stronger replacement status, making it less likely to be evicted. Conversely, when confidence is lower, the line can be installed with weaker replacement information, allowing it to be evicted more quickly if it proves not to be widely accessed.

While the implementations described above focus on using the LLC as the shared cache for Auto-Demote operations, the concept can be extended to other levels of the cache hierarchy or to different system architectures. For example, in systems with multiple LLCs or NUMA architectures, Auto-Demote could operate between different LLC domains, copying data to LLCs that are likely to service multiple local cores. Another example is in GPU or accelerator architectures, similar principles could be applied to manage data sharing between processing elements. A further example is in systems with coherent I/O devices, Auto-Demote could facilitate efficient data sharing between processor cores and peripheral devices.

In some implementations, the Auto-Demote system may be implemented using a non-transitory computer-readable medium storing instructions for execution by a processor. These instructions enable monitoring of cache access patterns in a multiprocessor system and detection of conditions indicating a likelihood of multiple processors reading a recently written cacheline. Upon detecting such conditions, the instructions trigger a copy of the recently written cacheline to a shared cache.

The Auto-Demote system has potential applications in various multiprocessor systems, from high-performance computing environments to consumer electronics with multi-core processors. In these systems, optimizing cache utilization is beneficial for maximizing computational throughput and improving overall system efficiency.

In an implementation, a method for managing cache data in a multicore processor system includes detecting a request for exclusive access to a cacheline by a first processor core, granting exclusive access to the cacheline to the first processor core and invalidating copies of the cacheline in other processor cores, after the first processor core writes to the cacheline, copying the cacheline to a last level cache (LLC) when a number of invalidated copies of the cacheline exceeds a predetermined threshold, and servicing read requests for the cacheline from the LLC.

The described implementations may also include one or more of the following features. The predetermined threshold is proportional to a total number of processor cores in the multicore processor system. Copying the cacheline to the LLC causes a state of the cacheline in the first processor core to transition from exclusive to shared. Applying a replacement policy to the copied cacheline in the LLC based on a number of invalidated copies. The LLC services multiple concurrent read requests for the cacheline from different processor cores without requiring access to the first processor core. Detecting a first read request for the cacheline from a second processor, detecting a second read request for the same cacheline from a third processor within a predetermined time period, and in response to the first and second read requests occurring within the predetermined time period, initiating a copy-back operation to copy the cacheline from a processor having most recent data for the cacheline to the LLC. Temporarily deferring service of the first and second read requests until completion of the copy-back operation. The predetermined time period corresponds to processing time of the first read request. The processor having most recent data has the cacheline in an exclusive state prior to the copy-back operation. The copy-back operation changes a coherency state of the cacheline in a processor core having most recent data from exclusive to shared.

In an implementation, a system for managing cache data includes a plurality of processor cores, each processor having at least one associated cache, a last level cache (LLC) shared by the plurality of processor cores, and a cache management circuit configured to detect when a first processor core of the plurality of processor cores obtains exclusive access to a cacheline and invalidates copies of the cacheline in other processor cores of the plurality of processor cores, after the first processor core performs a write to the cacheline, initiate a copy of the cacheline to the LLC when a number of invalidated copies of the cacheline exceeds a predetermined threshold, and service read requests for the cacheline from the LLC.

The described implementations may also include one or more of the following features. The predetermined threshold is dynamically adjusted based on system performance metrics. The cache management circuit is further configured to detect multiple read requests to the cacheline from different processor cores within a timeframe, and initiate a copy of the cacheline to the LLC in response to the multiple read requests. The cache management circuit is further configured to apply a replacement policy to the copied cacheline in the LLC based on anticipated access frequency. The cache management circuit is further configured to modify a coherency state of the cacheline in the first processor core from exclusive to shared when the cacheline is copied to the LLC. The cache management circuit is integrated within the LLC.

In an implementation, a system includes a plurality of processor cores, a shared cache accessible by the plurality of processor cores, and a cache management circuit integrated configured to detect when a first processor core of the plurality of processor cores obtains exclusive access to a cacheline after invalidating copies of the cacheline in at least a threshold number of other processor cores, copy the cacheline from the first processor core to the shared cache after the first processor core writes to the cacheline, and service read requests for the cacheline from the shared cache.

The described implementations may also include one or more of the following features. The cache management circuit is further configured to detect multiple read requests from multiple processor cores of the plurality of processor cores for the cacheline within a predetermined timeframe, and initiate a copy of the cacheline to the shared cache in response to the multiple read requests. The cache management circuit is further configured to apply a replacement policy to the copied cacheline in the shared cache based on a number of invalidated copies. The cache management circuit is further configured to downgrade a coherency state of the cacheline in the first processor core from exclusive to shared when copying the cacheline to the shared cache.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular implementations described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding implementations described herein. Accordingly, the appended claims are intended to include within their scope such processes, machines, manufacture, compositions of matter, means, methods, or steps.

1. A method for managing cache data in a multicore processor system, comprising:
detecting a request for exclusive access to a cacheline by a first processor core;
granting exclusive access to the cacheline to the first processor core and invalidating copies of the cacheline in other processor cores;
after the first processor core writes to the cacheline, copying the cacheline to a last level cache (LLC) when a number of invalidated copies of the cacheline exceeds a predetermined threshold; and
servicing read requests for the cacheline from the LLC.

2. The method of claim 1, wherein the predetermined threshold is proportional to a total number of processor cores in the multicore processor system.

3. The method of claim 1, wherein copying the cacheline to the LLC causes a state of the cacheline in the first processor core to transition from exclusive to shared.

4. The method of claim 1, further comprising:
applying a replacement policy to the copied cacheline in the LLC based on a number of invalidated copies.

5. The method of claim 1, wherein the LLC services multiple concurrent read requests for the cacheline from different processor cores without requiring access to the first processor core.

6. The method of claim 1, further comprising:
detecting a first read request for the cacheline from a second processor;
detecting a second read request for the same cacheline from a third processor within a predetermined time period; and
in response to the first and second read requests occurring within the predetermined time period, initiating a copy-back operation to copy the cacheline from a processor having most recent data for the cacheline to the LLC.

7. The method of claim 6, further comprising:
temporarily deferring service of the first and second read requests until completion of the copy-back operation.

8. The method of claim 6, wherein the predetermined time period corresponds to processing time of the first read request.

9. The method of claim 6, wherein the processor having most recent data has the cacheline in an exclusive state prior to the copy-back operation.

10. The method of claim 6, wherein the copy-back operation changes a coherency state of the cacheline in a processor core having most recent data from exclusive to shared.

11. A system for managing cache data, comprising:
a plurality of processor cores, each processor having at least one associated cache;
a last level cache (LLC) shared by the plurality of processor cores; and
a cache management circuit configured to:
detect when a first processor core of the plurality of processor cores obtains exclusive access to a cacheline and invalidates copies of the cacheline in other processor cores of the plurality of processor cores,
after the first processor core performs a write to the cacheline, initiate a copy of the cacheline to the LLC when a number of invalidated copies of the cacheline exceeds a predetermined threshold, and
service read requests for the cacheline from the LLC.

12. The system of claim 11, wherein the predetermined threshold is dynamically adjusted based on system performance metrics.

13. The system of claim 11, wherein the cache management circuit is further configured to:
detect multiple read requests to the cacheline from different processor cores within a timeframe; and
initiate a copy of the cacheline to the LLC in response to the multiple read requests.

14. The system of claim 11, wherein the cache management circuit is further configured to:
apply a replacement policy to the copied cacheline in the LLC based on anticipated access frequency.

15. The system of claim 11, wherein the cache management circuit is further configured to:
modify a coherency state of the cacheline in the first processor core from exclusive to shared when the cacheline is copied to the LLC.

16. The system of claim 11, wherein the cache management circuit is integrated within the LLC.

17. A system, comprising:
a plurality of processor cores;
a shared cache accessible by the plurality of processor cores; and
a cache management circuit integrated configured to:
detect when a first processor core of the plurality of processor cores obtains exclusive access to a cacheline after invalidating copies of the cacheline in at least a threshold number of other processor cores,
copy the cacheline from the first processor core to the shared cache after the first processor core writes to the cacheline, and
service read requests for the cacheline from the shared cache.

18. The system of claim 17, wherein the cache management circuit is further configured to:
detect multiple read requests from multiple processor cores of the plurality of processor cores for the cacheline within a predetermined timeframe; and
initiate a copy of the cacheline to the shared cache in response to the multiple read requests.

19. The system of claim 17, wherein the cache management circuit is further configured to:
apply a replacement policy to the copied cacheline in the shared cache based on a number of invalidated copies.

20. The system of claim 17, wherein the cache management circuit is further configured to:
downgrade a coherency state of the cacheline in the first processor core from exclusive to shared when copying the cacheline to the shared cache.
